(19) United States
(12) Patent Application Publication
(10) Pub. No.: US 2026/0042021 A1
(43) Pub. Date: Feb. 12, 2026

(54) AGE-SENSITIVE IMPLEMENTATION OF VIDEO GAME HELP SESSIONS

(71) Applicant: Microsoft Technology Licensing, LLC, Redmond, WA (US)

(72) Inventors: Monica Ann ADJEMIAN, Los Angeles, CA (US); Andrew H. FARRIER, Redmond, WA (US); Jennifer R. GURIEL, Kirkland, WA (US); Gershom PAYZER, Redmond, WA (US)

(73) Assignee: Microsoft Technology Licensing, LLC, Redmond, WA (US)

(21) Appl. No.: 18/798,139

(22) Filed: Aug. 8, 2024

(51) Int. Cl. A63F 13/79; A63F 13/5375; A63F 13/87; G06F 40/40; G06V 20/40

(52) U.S. Cl. CPC A63F 13/79; A63F 13/5375; A63F 13/87; G06F 40/40; G06V 20/41

(57) ABSTRACT

The disclosed concepts relate to managing help sessions within a video game based on age information associated with a video game player. For example, systems and associated methods scan perform age-based restriction of a help session using a variety of techniques. For instance, automated helpers can be selected for help sessions involving children, or messaging between a human helper and a child can be restricted using a range of communication techniques described herein.

### CROSS-REFERENCE TO RELATED APPLICATIONS

This application is related to, and incorporates by reference in their entirety, the following: US Patent Application No.: (Attorney Docket No. 057846-US01), US Patent Application No. ______ (Attorney Docket No. 502019-US01), US Patent Application No. ______ (Attorney Docket No. 502020-US01), US Patent Application No. ______ (Attorney Docket No. 502021-US01), and US Patent Application No. ______ (Attorney Docket No. 502018-US01).

### BACKGROUND

Video gamers often encounter difficult gaming situations, such as difficult enemies, difficult items to find, difficult levels to complete, etc. In some cases, video gamers will seek the assistance of other video gamers, e.g., by posting on online forums to get suggestions from other members of the video gaming community to overcome difficult parts of a given game. In other cases, video gamers consult online videos of other players demonstrating how to overcome difficult gaming situations. However, these techniques are rudimentary.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to video game help sessions. One example entails a computer-implemented method or technique that can include determining age information relating to a video game player engaged in a gaming session involving a video game. The method or technique can also include initiating a help session involving a helper assisting the video game player with gameplay of the video game. The method or technique can also include performing age-based restriction of the help session based at least on the age information. The method or technique can also include ending the help session and returning to the gaming session involving the video game player.

Another example entails a system that includes processing resources and storage resources. The storage resources can store computer-readable instructions which, when executed by the processing resources, cause the processing resources to determine age information relating to a video game player engaged in a gaming session involving a video game. The computer-readable instructions can also cause the system to initiate a help session involving a helper assisting the video game player with gameplay of the video game. The computer-readable instructions can also cause the system to perform age-based restriction of the help session based at least on the age information. The computer-readable instructions can also cause the system to end the help session and return to the gaming session involving the video game player.

Another example includes a computer-readable storage medium storing computer-readable instructions which, when executed by a hardware processing unit cause the hardware processing unit to perform acts. The acts can include determining age information relating to a video game player engaged in a gaming session involving a video game. The acts can also include initiating a help session involving a helper assisting the video game player with gameplay of the video game. The acts can also include performing age-based restriction of the help session based at least on the age information. The acts can also include ending the help session and returning to the gaming session involving the video game player.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example machine learning model, consistent with some implementations of the present concepts.

FIG. 2 illustrates an example computer vision model, consistent with some implementations of the present concepts.

FIG. 3 illustrates an example generative language model, consistent with some implementations of the present concepts.

FIGS. 4A and 4B illustrate example help session triggering conditions for a first video game, consistent with some implementations of the present concepts.

FIGS. 5A and 5B illustrate example help session triggering conditions for a second video game, consistent with some implementations of the present concepts.

FIGS. 6A, 6B, 6C, 6D, 6E, 6F, 6G, 6H, and 6I illustrate an example help session for the first video game, consistent with some implementations of the present concepts.

FIG. 7 illustrates an example workflow for implementing a help session, consistent with some implementations of the present concepts.

FIG. 8 illustrates an example system in which the present concepts can be employed.

FIG. 9 illustrates an example computer-implemented method for age-based restriction of help sessions, consistent with some implementations of the present concepts.

### DETAILED DESCRIPTION

### Overview

As noted above, video game players sometimes seek help from other video game players to overcome in-game difficulties, often by consulting online forums or videos. However, while this type of help is widely available, it takes a great deal of effort for users to seek out the assistance they need to accomplish their goal. Furthermore, these techniques may take the video game players out of the gaming experience while they search for external help content. Another alternative is to allow a helper to temporarily take over a video game to assist another video game player, but this can carry some risks, particularly when the player receiving assistance is a child.

The disclosed implementations address these issues by providing techniques that restrict help sessions in a manner that accounts for online security issues that concern children. For example, in some implementations, children can receive help from automated helpers, whereas human helpers may be provided for older game players. In another example, a child can be assigned a pre-approved human helper, e.g., based on a history of behavior by the pre-approved human helper in previous help sessions. In some implementations, communications from a helper to a child receiving assistance are selected from an approved group of communications, such as canned phrases, symbols, and/or emojis. In further examples, generative language models can be employed for communication purposes, e.g., by moderating messages received from a human helper or independently narrating a help session.

### Machine Learning Overview

There are various types of machine learning frameworks that can be trained to perform a given task, such as detecting triggering conditions and ending conditions for help sessions. Support vector machines, decision trees, random forests, and neural networks are just a few examples of suitable machine learning frameworks that have been used in a wide variety of other applications, such as image processing and natural language processing.

A support vector machine is a model that can be employed for classification or regression purposes. A support vector machine maps data items to a feature space, where hyperplanes are employed to separate the data into different regions. Each region can correspond to a different classification. Support vector machines can be trained using supervised learning to distinguish between data items having labels representing different classifications.

A decision tree is a tree-based model that represents decision rules using nodes connected by edges. Decision trees can be employed for classification or regression and can be trained using supervised learning techniques. Multiple decision trees can be employed in a random forest, which significantly improves the accuracy of the resulting model relative to a single decision tree. In a random forest, the individual outputs of the decision trees are collectively employed to determine a final output of the random forest. For instance, in regression problems, the output of each individual decision tree can be averaged to obtain a final result. For classification problems, a majority vote technique can be employed, where the classification selected by the random forest is the classification selected by the most decision trees.

A neural network is another type of machine learning model that can be employed for classification or regression tasks. In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs.

Various training procedures can be applied to learn the edge weights and/or bias values of a neural network. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, decoding, alignment, prediction, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned, e.g., individualized tuning to one or more particular users. Note that two trained models can share the same model structure and yet have different values for the internal parameters, e.g., if the two models are trained on different training data or if there are underlying stochastic processes in the training process.

### Terminology

The term “current game state,” or “game state,” as used herein, refers to the current location of the character, items accrued in their inventory, health status, etc. Game state can be explicitly provided by a video game and/or inferred from output of the video game. For instance, computer vision models and/or optical character recognition techniques can be applied to the video output of a video game to determine aspects of the game state.

The term “prior gameplay data,” as used herein, refers to various types of data associated with gameplay of a video game. Prior gameplay data can include gameplay sequences, e.g., inputs to a video game and/or outputs of the video game during prior gaming sessions. Prior gameplay data can also include communication logs relating to the game, such as in-game chat or voice sessions or external data such as forum posts regarding a particular game. Prior gameplay data can also include platform data collected by a video gaming platform, such as an online game playing service utilized by multiple video games or an operating system that runs on a gaming console. Prior gameplay data can also include instrumented game data that can be stored by the video game itself during execution for subsequent evaluation. Note that prior gameplay data can include very recent gameplay data obtained in real-time from live video game play.

A “help session” is an experience that occurs to assist a video game player with a particular portion of a video game. For instance, a help session can include a tutorial, e.g., text, chat, or video based. A help session can also include transferring control of a video game session to another game player that temporarily takes over control of a video game until the help session is completed. The other game player can be a human being or a trained machine learning model.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as ChatGPT, BLOOM, PaLM, Mistral, Gemini, and/or LLAMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a multi-modal generative model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include CLIP models, certain GPT variants such as GPT-4o, Gemini, etc.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Neural Network

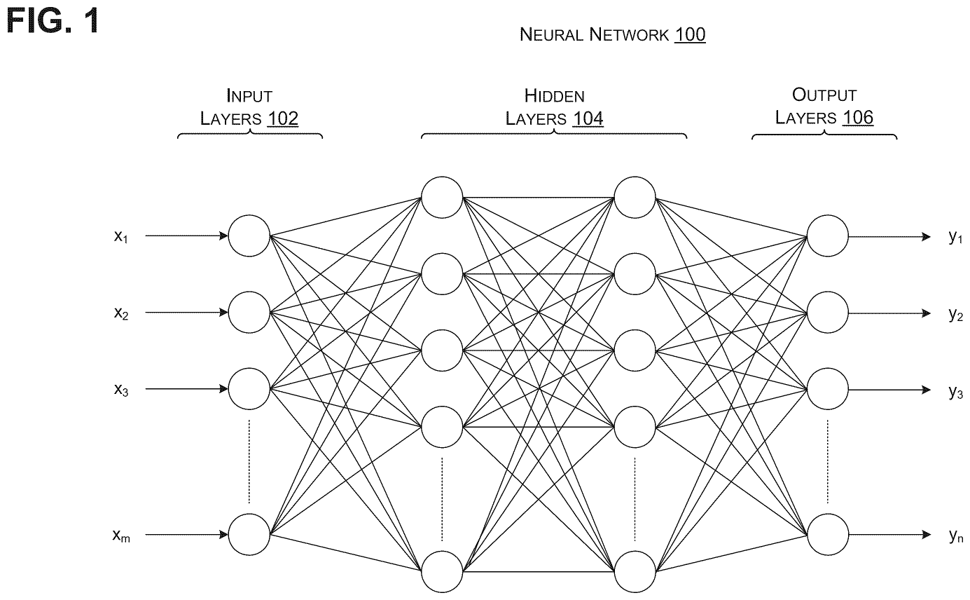

FIG. 1 shows a deep neural network 100 with input layers 102, hidden layers 104, and output layers 106. The input layers can receive features x₁ through xₘ. For instance, the features can relate to prior gameplay data for one or more video games and can include features relating to gameplay sequences by one or more players, features relating to communication logs from players discussing the video game, features relating to platform data collected by a gaming platform that executes the video game, and/or game data (e.g., telemetry) collected by the video game itself when executing.

The input layers can feed into the hidden layers 104. The hidden layers feed into the output layers 106. The output layers can output values y₁ through yₙ. For instance, the output values can characterize any aspect of video game play at any point during the video game. In some cases, the output values are calculated using a regression approach, and in other cases using a classification approach.

For instance, in a regression approach, a neural network could be trained to produce a numerical trust score for a control input or video game output based on input features relating to the control input, video game state, and/or the history of the helper. The trust score can reflect the extent to which the control input or video game output is deemed appropriate during a help session involving a child. The control input can be restricted or allowed depending on whether the trust score exceeds a threshold. In a classification approach, the neural network can be trained to produce Boolean values indicating whether a given input or game output is trusted or untrusted (e.g., should be restricted for children) based on similar input features.

Neural network 100 is shown with a general architecture that can be modified depending on the task being performed by the neural network. For instance, neural networks can be implemented with convolutional layers to implement a computer vision model or as a transformer encoder/decoder architecture to implement a generative language or multi-modal generative model. Neural networks can also have recurrent layers such as long short-term memory networks, gated recurrent units, etc.

### Example Computer Vision Model

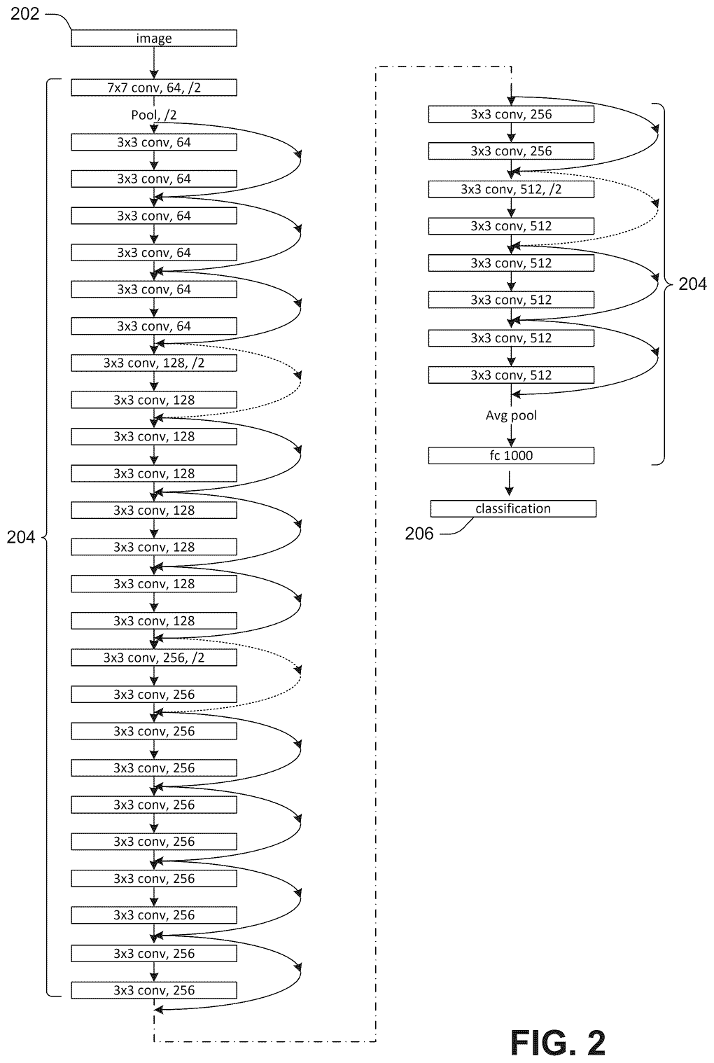

While FIG. 1 illustrates a general architecture of a neural network, FIG. 2 illustrates a particular example of a neural network model for computer vision. For instance, FIG. 2 shows an image 202 being classified by a computer vision model 204 to determine an image classification 206. For instance, the image can include part or all of a video frame output by a video game, and computer vision model 204 can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters. If the feature map size is halved by a given convolutional layer (as shown by “/2” in FIG. 2), then the number of filters can be doubled to preserve the time complexity across layers.

After the image has been processed using a series of convolutional layers, the image is processed in a global average pooling layer. The output of the pooling layer is processed with a 1000-way fully connected layer with softmax. The fully connected layer can be used to determine a classification, e.g., an object category of an object in image 202.

The respective layers within computer vision model 204 can have shortcut connections which perform identity operations:

$$y = F ( x , \{ {W}_{i} \} ) + x \qquad ( 1 )$$

where x and y are the input and output vectors of the layers involved and F(x,{Wᵢ}) represents the residual mapping to be learned. In some connections the dimensions increase across layers (shown as dotted lines in FIG. 2). In these cases, the following projection can be employed to match the dimensions via 1×1 convolutions:

$$y = F ( x , \{ {W}_{i} \} ) + {W}_{s} x \qquad ( 2 )$$

In some implementations, computer vision model 204 can be pretrained on a large dataset of images, such as ImageNet. Such a general-purpose image database can provide a vast number of training examples that allow the model to learn weights that allow generalization across a range of object categories. Said another way, computer vision model 204 can be pretrained in this fashion.

After pretraining, computer vision model 204 can be tuned on another, smaller dataset for categories of interest. For instance, tuning datasets can be provided for specific video games, genres of video games, etc. As one example, some genres of video games tend to have health status bars or important, powerful enemies (“bosses”), and computer vision model 204 could be tuned to detect health status and/or boss fight scenarios using training data from multiple games from a particular genre. For instance, the training data could include video frames with associated labels, e.g., either manually labeled health bars or boss fights or implicit labels obtained from user chat logs, forum discussions, etc. In some examples, the computer vision model 204 can also be tuned to detect objects in video output of a video game that may be of concern to children. For instance, the computer vision model could be tuned to detect a menu to change a child safety setting, a set of symbols deemed inappropriate for children, violent or sexual content, etc.

### Example Decoder-Based Generative Language Model

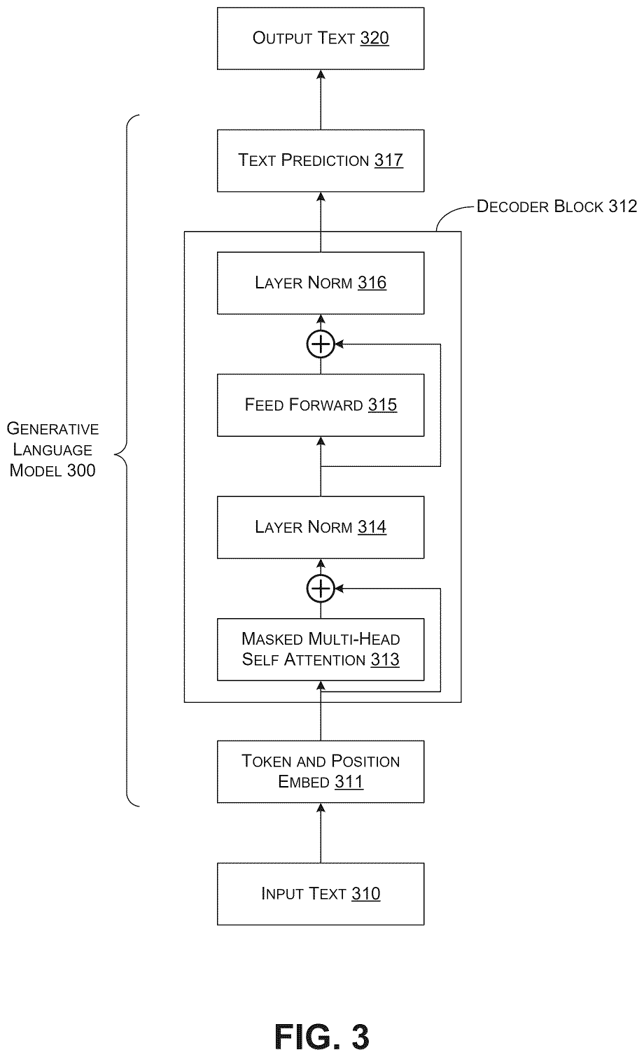

While FIG. 1 illustrates a general architecture of a neural network, FIG. 3 illustrates a particular example of a neural network model for language generation. Specifically, FIG. 3 illustrates an exemplary generative language model 300 (e.g., a transformer-based decoder) that can be employed using the disclosed implementations. The generative language model 300 is an example of a machine learning model that can be used to perform one or more natural language processing tasks that involve generating text, as discussed more below. For the purposes of this document, the term “natural language” means language that is normally used by human beings for writing or conversation.

The generative language model 300 can receive input text 310, e.g., a prompt from a user or a prompt generated automatically by machine learning using the disclosed techniques. For instance, the input text can include words, sentences, phrases, or other representations of language. The input text can be broken into tokens and mapped to token and position embeddings 311 representing the input text. Token embeddings can be represented in a vector space where semantically similar and/or syntactically similar embeddings are relatively close to one another, and less semantically similar or less syntactically similar tokens are relatively further apart. Position embeddings represent the location of each token in order relative to the other tokens from the input text.

The token and position embeddings 311 are processed in one or more decoder blocks 312. Each decoder block implements masked multi-head self-attention 313, which is a mechanism relating different positions of tokens within the input text to compute the similarities between those tokens. Each token embedding is represented as a weighted sum of other tokens in the input text. Attention is only applied for already-decoded values, and future values are masked. Layer normalization 314 normalizes features to mean values of 0 and variance to 1, resulting in smooth gradients. Feed forward layer 315 transforms these features into a representation suitable for the next iteration of decoding, after which another layer normalization 316 is applied. Multiple instances of decoder blocks can operate sequentially on input text, with each subsequent decoder block operating on the output of a preceding decoder block. After the final decoding block, text prediction layer 317 can predict the next word in the sequence, which is output as output text 320 in response to the input text 310 and also fed back into the language model. The output text can be a newly generated response to the prompt provided as input text to the generative language model.

The generative language model 300 can be trained using techniques such as next-token prediction or masked language modeling on a large, diverse corpus of documents. For instance, the text prediction layer 317 can predict the next token in a given document, and parameters of the decoder block 312 and/or text prediction layer can be adjusted when the predicted token is incorrect. In some cases, a generative language model can be pretrained on a large corpus of documents (Radford, et al., “Improving language understanding by generative pre-training,” 2018). In other examples, a generative language model could be tuned using training data from a specific video game or games from a particular genre to learn how to generate text describing the video game using child-appropriate language. For instance, a curated corpus of natural language descriptions of video game output could be obtained, where the corpus includes spoken or text descriptions by video game players of a game. The corpus could include both positive and negative examples of child-appropriate language. This could allow the generative language model to independently narrate a help session and/or moderate language provided by a helper during a help session.

In the context of FIG. 2, objects detected by the computer vision model 204 can be passed on to generative language model 300 as one type of game state. The generative model 300 can be tuned to learn whether video game inputs from a helper and/or outputs of the video game are potentially inappropriate for children.

### Example Adventure Game Sequences

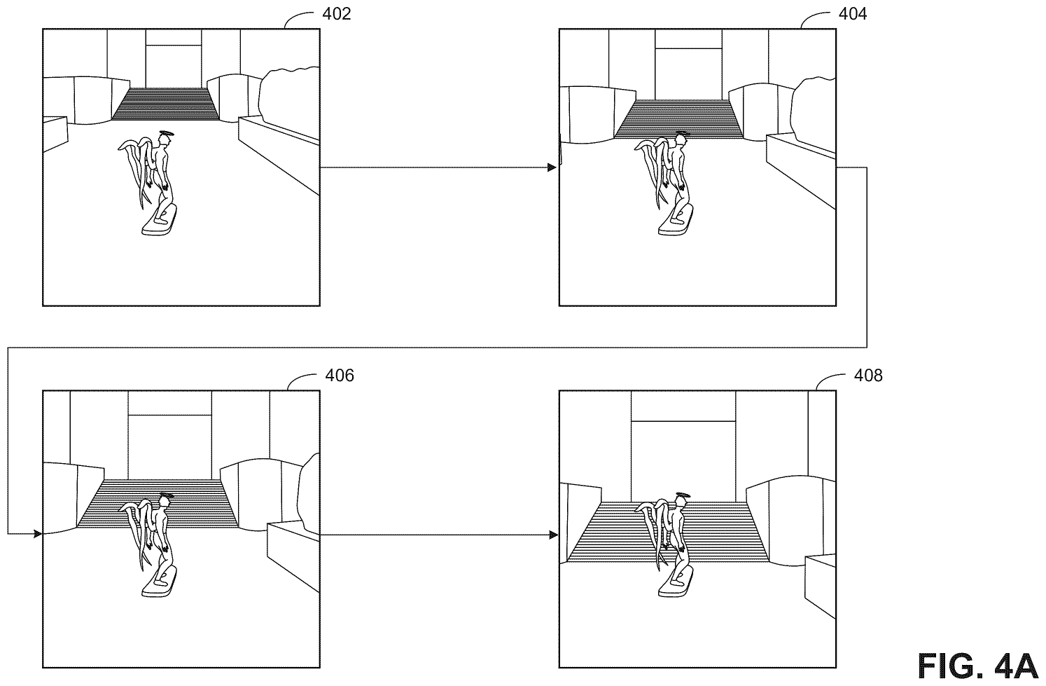

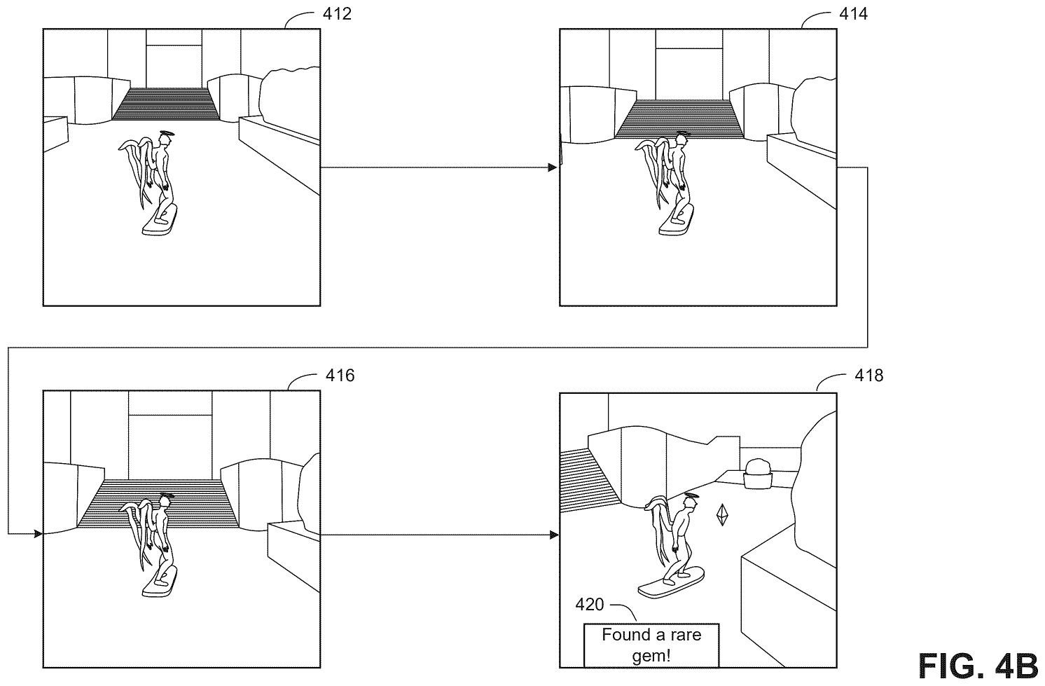

FIG. 4A shows a sequence of frames from an adventure game where a video game player controls a character riding a hoverboard. The character moves forward through frame 402, frame 404, frame 406, and frame 408, looking for a rare gem. However, the video game player is unsuccessful at finding the rare gem in this sequence of frames. FIG. 4B shows a sequence of frames from the adventure game where the character moves through a similar sequence of frames. Frame 412 is similar to frame 402, frame 414 is similar to frame 404, and frame 416 is similar to frame 406. However, unlike frame 408, at frame 418 the character turns to the right and finds a rare gem. An achievement 420 is displayed in frame 418 indicating that the user has found a rare gem.

For the purposes of the following discussion, assume that many video game players struggle with finding the rare gem and that FIG. 4A illustrates a relatively common sequence of frames. In other words, users tend to navigate too far without turning to the right at the proper time and thus do not find the rare gem. Said another way, finding the rare gem is a difficult in-game goal. Further, assume that many video game players also tend to disengage from gameplay as a result of getting frustrated by not finding the rare gem. As described more below, this can be mitigated by identifying a help session triggering condition in the video game when a current video player is in the vicinity of the rare gem and offering that player assistance at finding the rare gem during a help session. The help session can be automatically ended when the current video game player finds the rare gem, e.g., finding the rare gem can be designated as a help session ending condition.

### Example Racing Game Sequences

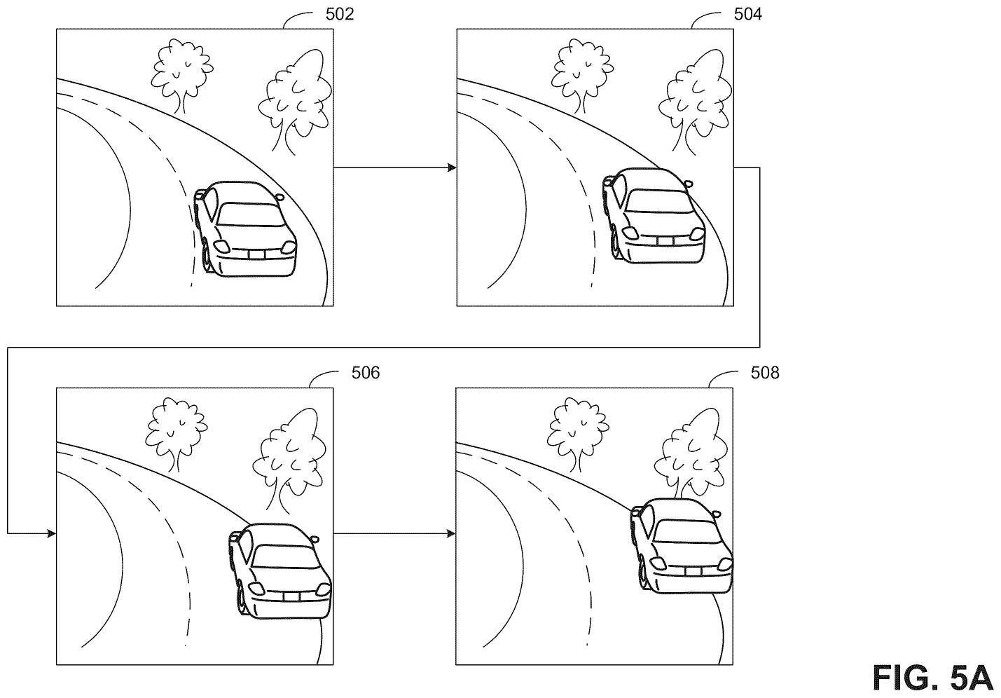

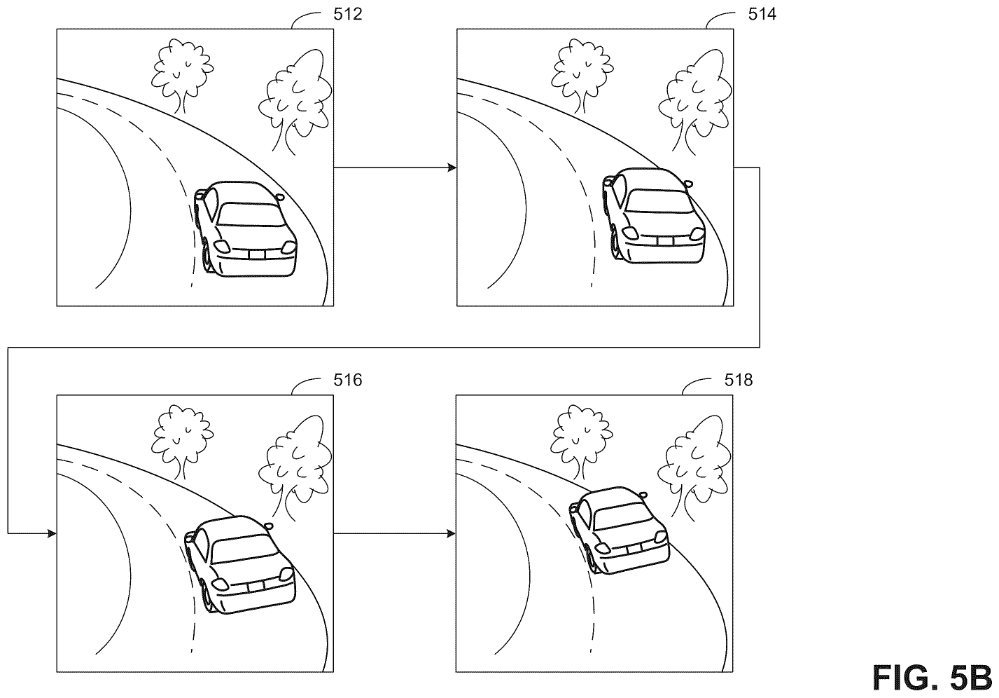

FIG. 5A shows a sequence of frames from a racing game where a video game player controls a car along a road course. The car moves forward through frame 502, frame 504, frame 506, and frame 508, eventually crashing into a tree. FIG. 5B shows a sequence of frames from the racing game where the car starts at a similar location in frame 512 to the location shown in frame 502. However, in frame 514, the car takes a different path that proceeds through frames 516 and 518, successfully staying on the road course without crashing into the tree.

For the purposes of the following discussion, assume that many video game players struggle with running into the tree, and that FIG. 5A illustrates a relatively common sequence of frames. In other words, video game players tend to misjudge this particular turn and veer into the tree rather than staying on the road when playing the game. Said another way, running into the tree is a common negative in-game consequence in the racing game. Further, assume that many video game players also tend to disengage from gameplay as a result of getting frustrated by running into the tree. As described more below, this can be mitigated by identifying a help triggering condition in the video game when a current video player is approaching the tree and offering the current video game player assistance at successfully navigating the turn during a help session. The help session can be automatically ended when the current video game player successfully navigates the turn, e.g., passing the tree without crashing can be designated as a help session ending condition.

### Example Adventure Game Help Session

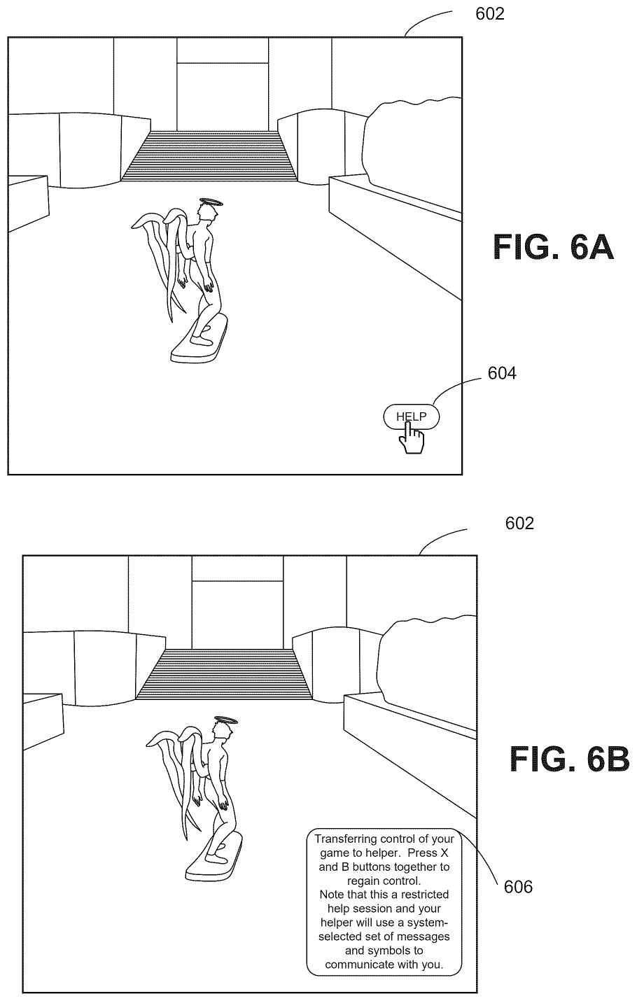

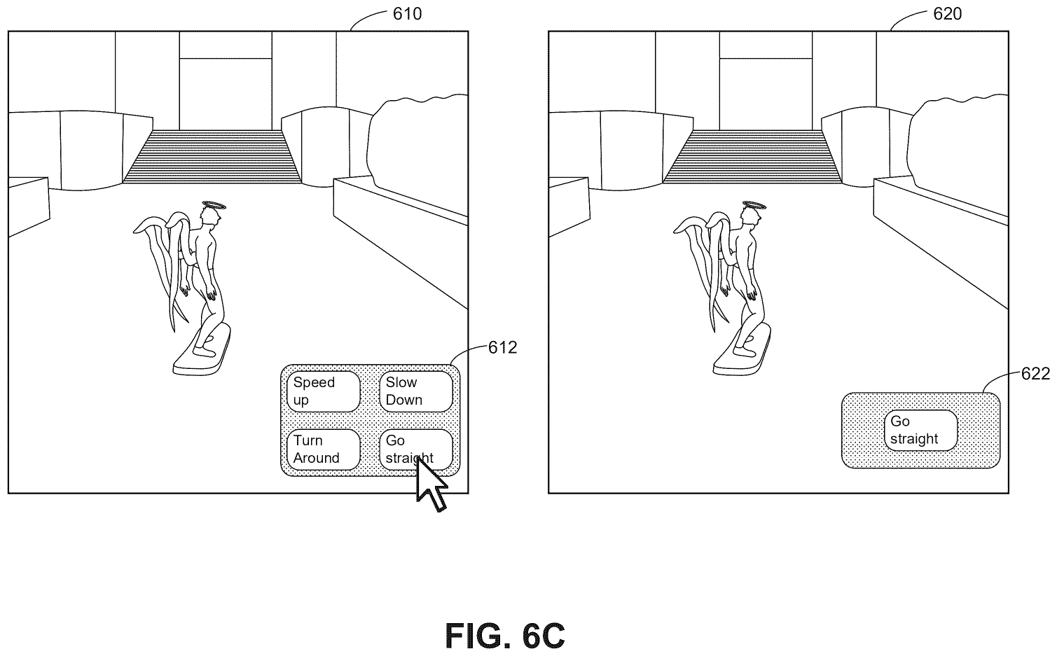

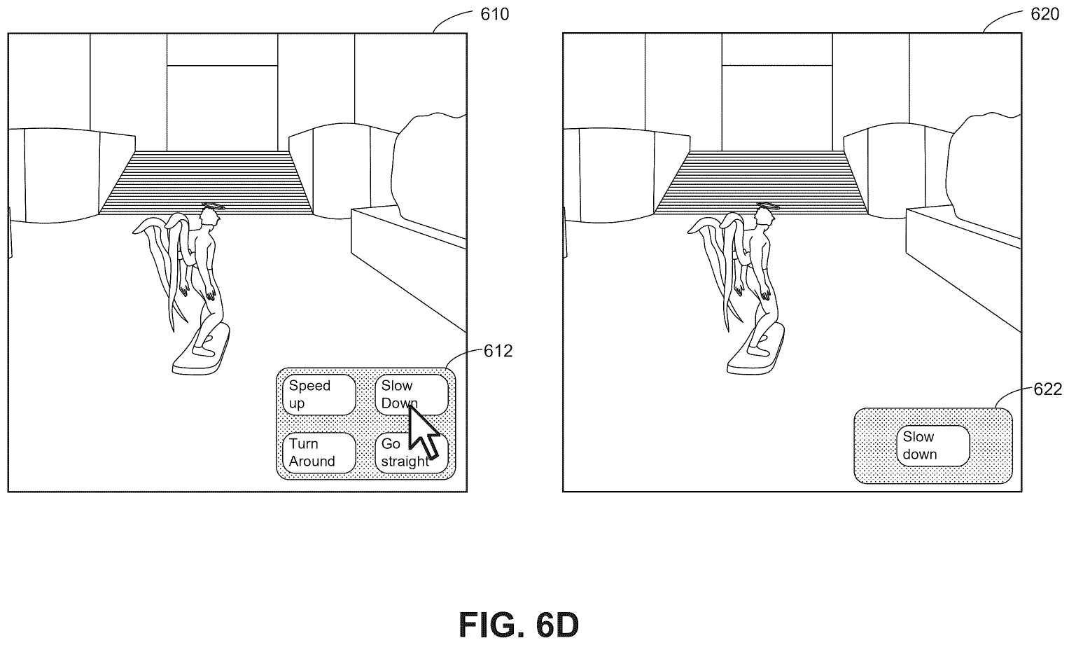

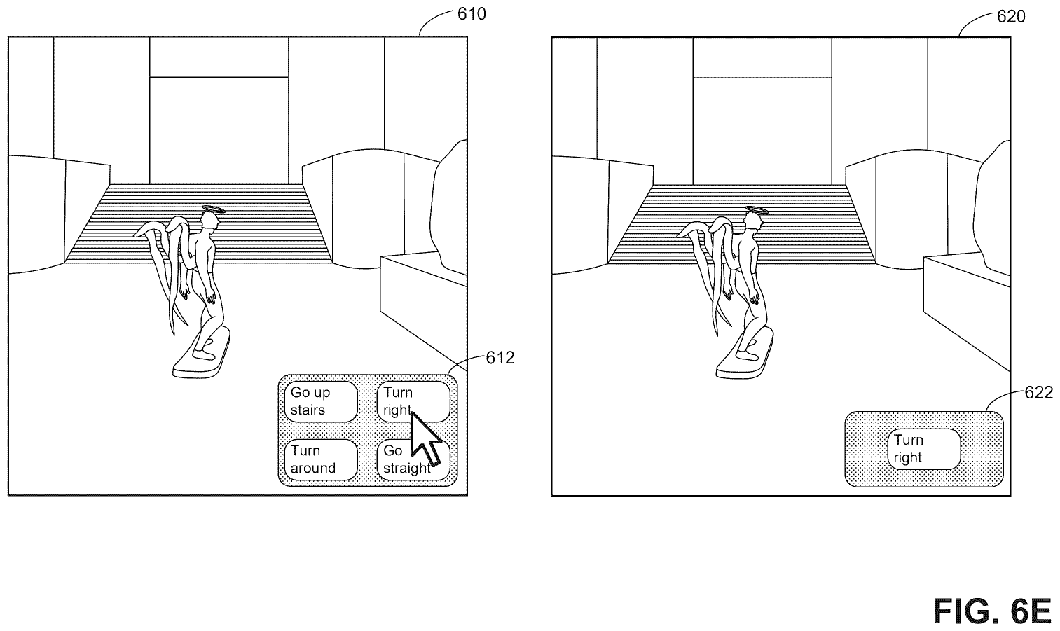

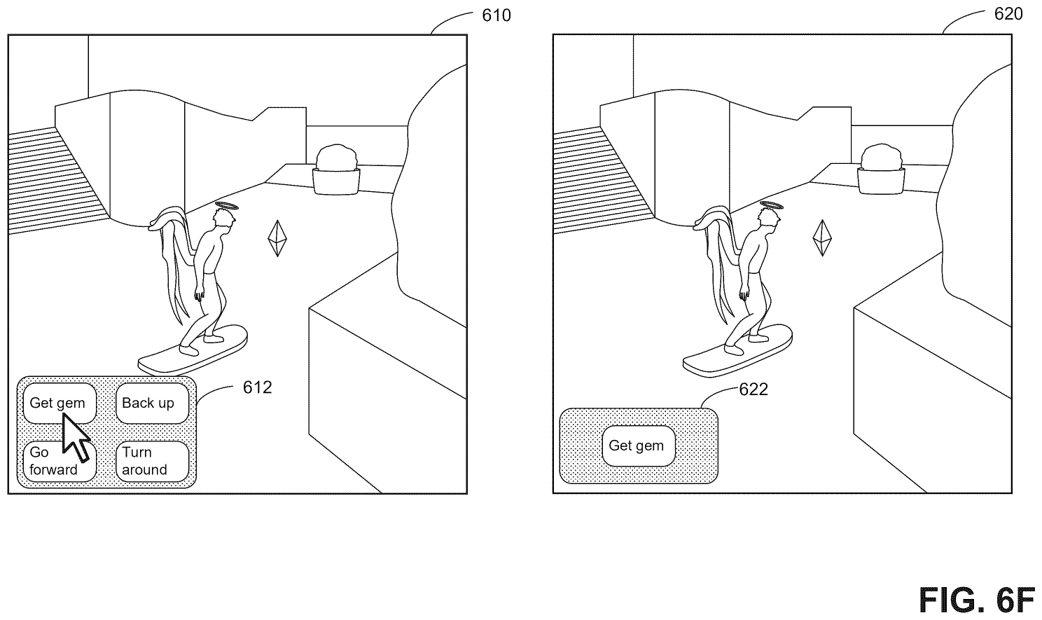

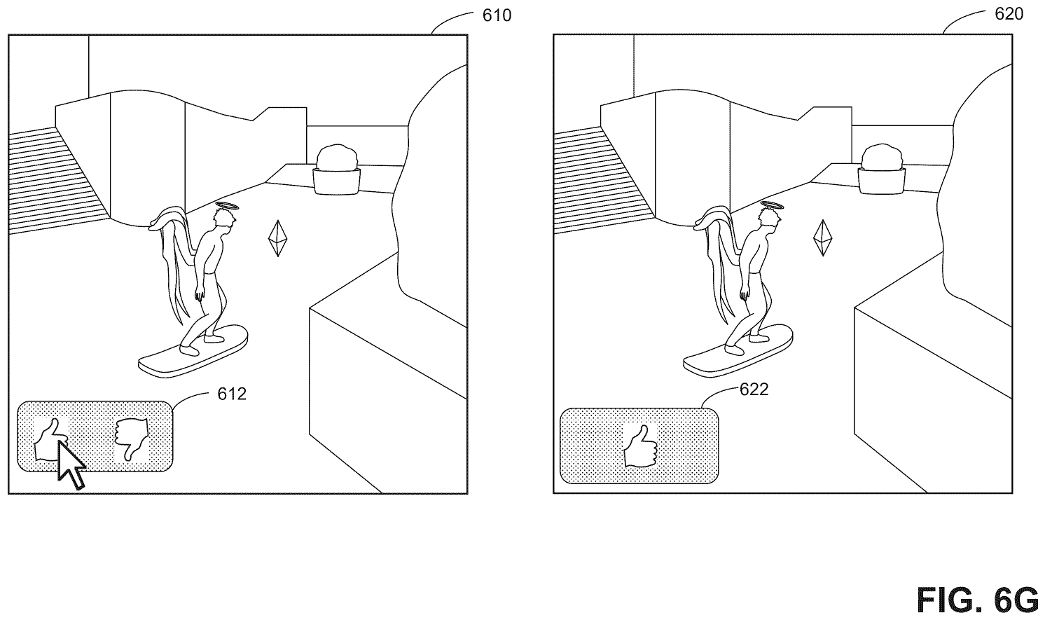

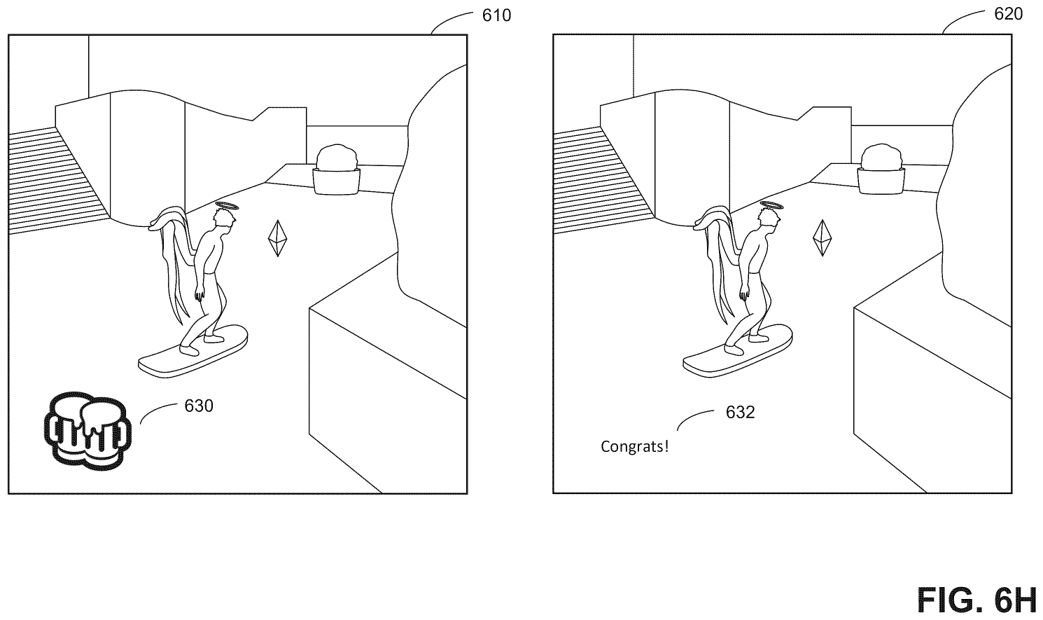

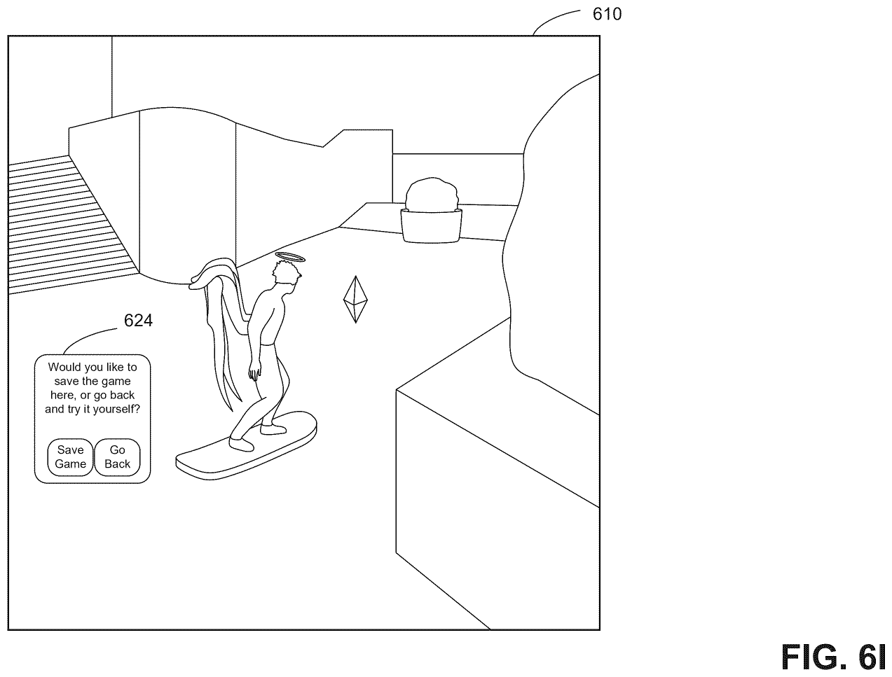

FIGS. 6A through 6I collectively illustrate an example help session experience relating to the adventure video game introduced previously. FIG. 6A shows a help session triggering condition being detected in a current video game session. Note that a video frame 602 is visually similar to frame 402 and frame 412, as discussed above with respect to FIGS. 4A and 4B. One way to detect that a help session should be offered during a current video game session is to compare the output of the current video game session to prior outputs associated with prior help sessions, e.g., by comparing embeddings representing video and/or audio output. When one or more embeddings for the current video game session are sufficiently similar to the one or more embeddings associated with the prior help sessions, the help session can be triggered.

When the help session triggering condition is detected, a help icon 604 can be presented on the screen, as shown in FIG. 6A. When the current video game player selects the help icon, the current game state can be saved as a help session starting state, and the help session can proceed as follows. For instance, the current game state can represent the location of the character, items accrued in their inventory, health status, etc. Next, a help session transfer notification 606 is shown indicating control is being transferred to the helper, as shown in FIG. 6B. The help session transfer notification also explains that this is a restricted help session and that communication will involve messages and symbols selected by a system for communication.

FIG. 6C shows a helper view 610 and a helpee view 620. For the following example, assume that the video game player being helped is a child, and the child will view helpee view 620 during the help session. Further, assume that the helper is a human being and that the video game is being controlled by the helper during the help session. The helper view includes message options 612, which allow the helper to communicate messages to the helpee from a set of approved messages. Here, the helper selects the option “go straight” and continues to control the character along a straight path. The helpee view includes a message window 622, which shows the message selected by the helper.

Next, in FIG. 6D, the character continues along the path. The helper selects the “slow down” message from message options 612 in the helper view 610 and controls the character to slow down when approaching the stairs. The helpee view 620 is updated so that message window 622 shows the “slow down” message.

Next, in FIG. 6E, the character continues further along the path. The helper selects the “turn right” message from message options 612 in the helper view 610 and controls the character to initiate a turn toward the right. The helpee view 620 is updated so that message window 622 shows the “turn right” message.

Next, in FIG. 6F, a rare gem is visible. The helper selects the “get gem” message from message options 612 in the helper view 610. The helpee view 620 is updated so that message window 622 shows the “get gem” message in the helpee view 620.

Next, in FIG. 6G, the message options 612 is updated with two available symbols, a thumbs-up symbol and a thumbs-down symbol. The helper selects the thumbs-up symbol from the helper view 610. Then, the message window 622 in the helpee view 620 is updated to show the thumbs-up symbol.

As discussed more below, message options 612 and message window 622 can be implemented as system-level functionality. For instance, a remote gaming service or operating system may provide such messaging functionality during a video game, where the functionality is implemented outside of the video game. However, in some cases, a game may also have built-in functionality to allow helpers to enter symbols or other forms of messages. For instance, a game may allow users to draw symbols or select symbols (e.g., emojis) from a menu. FIG. 6H shows an alternative scenario where instead of a thumbs-up message, the helper has drawn a cheers symbol 630 or selected the symbol (e.g., an emoji) from an in-game menu. Since this symbol implies alcoholic beverages, it may be removed in some implementations. For instance, system level functionality can employ a helpee message 632 to replace the cheers emoji with the text “Congrats.”

At this time, control can return to the current video game player, e.g., the presence of the rare gem in the current video game frame can be designated as a help session ending condition. Note that the help session can be automatically ended at this point according to a help session ending condition, e.g., indicating that the rare gem was found and/or based on a comparison of an embedding representing the video frame shown in FIG. 6H to an average embedding of successful help sessions that resulted in finding the rare gem.

Next, in FIG. 6I, a help session acceptance option 624 is displayed. If the current video game player wishes to accept the option, the updated state of the video game can be loaded into the current video gaming session. Then, the current video game player can resume play from that state, e.g., having just found the rare gem. If the help session acceptance option is rejected, the current video game session can return to the help session starting state and the current video game player can attempt to find the rare gem themselves.

Referring back to FIGS. 6C through 6F, note that the available natural language messages in message options 612 can be updated in a context-sensitive manner as the character moves along the path toward the gem. In FIGS. 6C and 6D, the options include “speed up,” “slow down,” “turn around,” and “go straight.” As the character approaches the turn to the right in FIG. 6E, the message options window is updated to include options to “go up stairs” and “turn right.” These options can be based on the proximity of the character to the stairs and to the right turn becoming available to the character at this time. Likewise, as the gem becomes visible in FIG. 6F, the options to “get gem” or “back up” become available. Likewise, the thumbs-up and thumbs-down messages shown in FIG. 6G can be determined based on context, e.g., since the helper is finished finding the gem, the thumbs-up message can be used to indicate the gem has been found. Additional details are described below relating to how context-sensitive messages can be selected in response to the changing game state.

### Example Workflow

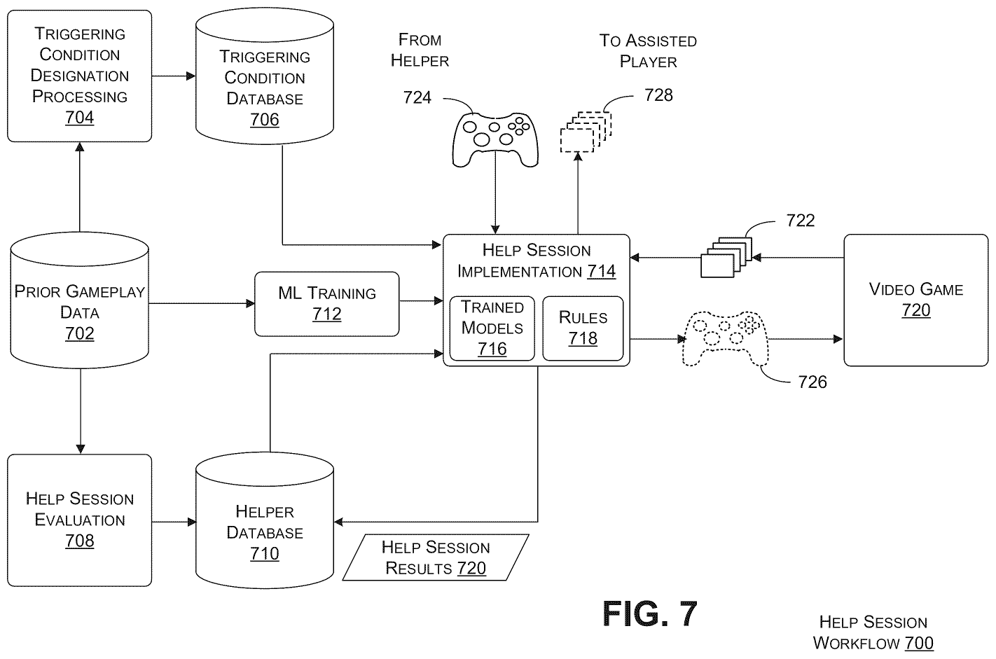

FIG. 7 shows an example help session workflow 700. Various sources of prior gameplay data 702 can be employed for designating help session triggering or ending conditions for a video game. The prior gameplay data can also be evaluated to evaluate video game helpers. For instance, the gameplay data can include gameplay sequences, communication logs, platform data, and instrumented game data, etc.

Gameplay sequences can include various sequences of video game outputs (video, audio, and/or haptic) and/or inputs obtained from one or more prior video gaming sessions. Optical character recognition can be performed on video frames in the gameplay sequences to obtain on-screen text features. In addition, machine learning can be performed on the video frames, audio output, and/or video game input to obtain ML-detected features. For instance, the ML-detected features can include object identifiers or embeddings obtained using computer vision model 204, described previously.

Communication logs can include chat or voice logs obtained during prior gaming sessions, e.g., communications between video game players when playing a particular video game. The communication logs can also include other types of communications, such as online forum discussions relating to a particular video game. The communication logs can be processed using natural language processing to obtain natural language processing features. For example, the natural language processing features can include sentiment relating to specific game scenarios.

Platform data can include data collected by a video gaming platform on which one or more video games can be executed. The platform data can include in-game achievements, saves, restarts, disengagement data, etc. The platform data can be processed using machine learning, rules, or statistical techniques to extract platform features.

Instrumented game data can include telemetry data collected by one or more video games. For example, games can track data such as levels completed, enemies defeated, etc. The instrumented game data can be processed using machine learning, rules, or statistical techniques to extract instrumented game data features.

The various features extracted from the prior gameplay data can be input to triggering condition designation processing 704. For instance, the triggering condition designation processing can involve applying one or more rules to the features to determine what conditions in a given video game will trigger a help session to begin and/or end. For instance, a rule could state that any condition that results in above a threshold percentage (e.g., 5%) of users disengaging after encountering that condition is designated as a help session triggering condition. In the examples above, the failure of a user to find a rare gem five times and then returning to the same location in the adventure game could be an example of a help session triggering condition. Similarly, a user crashing into a tree in a video game five times and then returning again to the same location on the track could be an example of a help session triggering condition.

In other cases, a machine learning model could be employed to designate help session triggering conditions. For instance, a generative language model or multi-modal generative model could be provided with features reflecting user disengagement (e.g., from platform data). As another example, a generative model could be provided features reflecting negative in-game consequences or difficult in-game goals. The generative model could identify these conditions as appropriate conditions for triggering help sessions. In some cases, rules and/or machine learning models can also be employed to designate help session ending conditions as well.

Once the help session triggering conditions have been designated, they can be used to populate a triggering condition database 706. The triggering condition database can include one or more help session triggering conditions (and possibly ending conditions) for one or more video games. Over time, the triggering condition database can evolve as circumstances change, such as updates to the video game(s).

In addition, the gameplay data can be processed by help session evaluation 708. In help session evaluation 708, the gameplay data for various help sessions is analyzed. A helper database 710 is populated based on the analysis. For instance, the helper database can include records for various video game helpers. The records can characterize how successful different video game helpers are on an overall basis, for specific video games, and/or at specific segments of video games, as described more below. The records can also characterize whether the helpers used child-appropriate language or other behaviors during the help sessions.

In addition, ML training 712 can train one or more machine learning models as described herein. The trained models can be employed to determine when a help session should be restricted (e.g., by preventing one or more control inputs from being provided to a video game) and/or ended based on the age of a video game player receiving assistance. In addition, the trained models can be employed to detect help session triggering and/or ending conditions, to detect objects in output of a video game, etc. Furthermore, the trained machine learning models can be employed to modify input from a helper and/or output of a video game based on the age of the player receiving assistance.

As noted above, help session implementation 714 can involve determining whether a current gaming session matches any of the triggering conditions in the triggering condition database 706. If so, then a help session can be initiated for the current video game player. The help session implementation can also involve determining when to end a help session, e.g., when a current video game player presses a specific button or buttons on their controller, or a help session ending condition is detected during gameplay. The help session implementation can also involve determining whether any helpers from helper database 710 are available and potentially selecting and/or ranking individual video game helpers for the help session.

Help session implementation 714 can employ the trained machine learning models 716 and/or one or more rules 718 to perform runtime restriction of inputs during a help session for video game 720. For instance, if a help session triggering condition is detected in output 722 of the video game, then a help session can be initiated. Helper inputs 724 can be received from a video game helper and can be restricted to obtain restricted inputs 726. In some cases, output 722 can also be restricted to obtain restricted output 728. For instance, in some implementations, a video feed can be modified to remove a symbol, drawing, and/or term that may be inappropriate for children.

### Example System

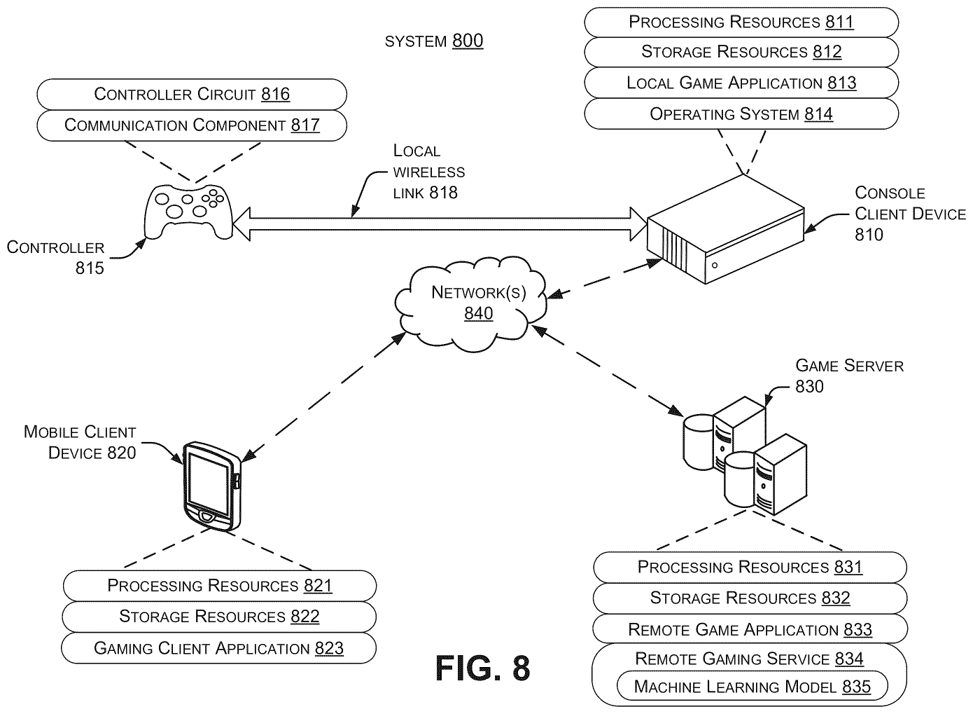

The present concepts can be implemented in various technical environments and on various devices. FIG. 8 shows an example system 800 in which the present concepts can be employed, as discussed below. As shown in FIG. 8, system 800 includes a console client device 810, a mobile client device 820, and a game server 830. Console client device 810, mobile client device 820, and server 830 are connected over one or more networks 840.

Console client device 810 can have processing resources 811 and storage resources 812, mobile client device 820 can have processing resources 821 and storage resources 822, and game server 830 can have processing resources 831 and storage resources 832. The devices of system 800 may also have various modules that function using the processing and storage resources to perform the techniques discussed herein, as discussed more below.

Console client device 810 can include a local game application 813 and an operating system 814. The local game application can execute using functionality provided by the operating system. The operating system can obtain control inputs from controller 815, which can include a controller circuit 816 and a communication component 817. The controller circuit can digitize inputs received by various controller mechanisms such as buttons or analog input mechanisms such as joysticks. The communication component can communicate the digitized inputs to the console client device over the local wireless link 818. The control interface module on the console can obtain the digitized inputs and provide them to the local application. The operating system can collect platform data during execution, and the game can collect instrumented game data during execution. As with previously described figures, the functions of the various components of the system can be dispersed throughout a network, be executed locally, or a combination of both.

Mobile client device 820 can have a gaming client application 823. The gaming client application can send inputs from a touchscreen on the mobile client device and/or peripheral game controller to the server 830, and can also receive game outputs, such as video, chat, and/or audio streams, from the server(s) and output them via a display, loudspeaker, headset, etc.

Server 830 can include a remote game application 833, which can correspond to a streaming version of a video game. The server 830 can also have a remote gaming service 834, which can execute the remote game application and provide various support services, such as maintaining user accounts, tracking achievements, etc. The remote game platform can also train a machine learning model 835 using prior gameplay data from help sessions for games offered by the platform and then execute the trained machine learning model to provide an automated help session. For instance, the trained machine learning model can be employed to restrict inputs and/or outputs during a help session involving a child.

When a help session is initiated for a game executed on the console client device 810, a cloud instance of a streaming version of the video game can be instantiated by the remote gaming service to provide a cloud-based help session. Then, the saved game state from the console can be used as an initial state for the help session, running on the cloud instance. When completed, the game state of the streaming session can be sent to the console, and the current user can resume gameplay from that state. In this case, the help session workflow 700 can be performed by the remote game service during the help session, e.g., by restricting which inputs received from a client device of the helper (such as mobile client device 820) are received by the game executing on the game server.

Various other execution scenarios are contemplated. For instance, some implementations can involve running an automated help session on another local console of the helper, and an operating system on the console of the helper can restrict inputs and/or outputs as described herein. Streaming output from the helper console can be sent over the network to the client device of the player receiving assistance. In other cases, both the current gaming session and the help session are streaming cloud instances of the video game. For help sessions involving local restriction of helper inputs, the game server 830 can distribute one or more trained machine learning models 835 to one or more client devices for local execution thereon. The trained machine learning models can be employed by the operating system on the client devices to trigger help sessions, end help sessions, and/or restrict help session inputs as described previously. In other cases, the remote gaming service and/or operating system can be programmed with one or more rules for restricting inputs/outputs during help sessions involving children.

### Example Method

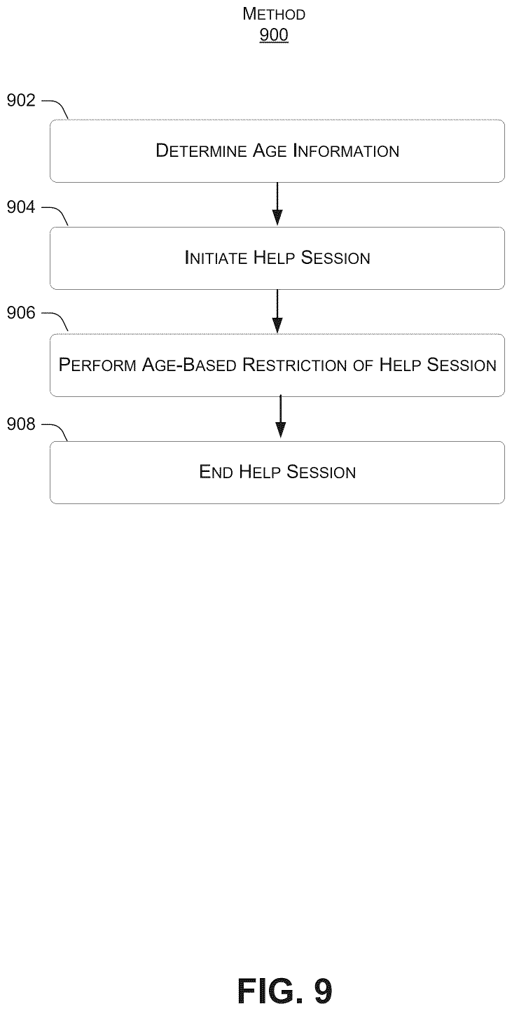

FIG. 9 illustrates an example computer-implemented method 900 for use in selectively and dynamically restricting helper access during a help session of a video game. As discussed herein, method 900 can be implemented on many different types of devices, e.g., by one or more cloud servers, by a client device such as a laptop, tablet, or smartphone, or by combinations of one or more servers, client devices, etc.

Method 900 begins at block 902, where age information for a video game player engaged in a gaming session is determined. For instance, the video game player may have a profile with an online gaming service and their age may be part of their profile. In other cases, a machine learning model can be employed to detect the age of the game player based on features such as their play style, preferences, vocabulary, etc.

Method 900 continues at block 904, where a help session is initiated. For example, a help session can be initiated by a manual request from a current video game player, e.g., by pressing a designated sequence of buttons on a video game controller. In other examples, the help session is automatically initiated responsive to a triggering condition as described elsewhere herein, such as when the game player is identified to be struggling or is at a point in the video game where new game players are known to benefit from help.

Method 900 continues at block 906, where age-based restriction of the help session is performed. For instance, the age-based restriction can involve selecting a particular (e.g., preapproved human or automated) helper when the age information indicates the video game player is below a designated age threshold. The age-based restriction can also involve restricting communication to/from the helper and video game player, and/or restricting visible on-screen content during the help session.

At block 908, the help session is ended. For instance, the helper and/or assisted game player can end the help session using designated sequences of control inputs. In other cases, the help session can be ended when a help session ending condition is detected in output of the video game.

### Further Implementations

A wide range of techniques can be employed for help session restriction, consistent with the present concepts. For instance, referring back to FIGS. 6C through 6F, some implementations may use a system overlay for message options 612 and/or message window 622. In other words, these graphical user interface elements may be rendered on top of video game output produced by a video game being executed by a remote gaming service and/or operating system.

To populate the message options, computer vision can be employed, e.g., using a computer vision model in cooperation with a separate generative language model and/or using a multi-modal generative model. For instance, computer vision can detect that the character cannot turn right without running into a wall during the states shown in FIGS. 6C and 6D, so those options are not provided. Instead, a generative language or multi-modal model can be prompted to provide four short, child-appropriate messages describing the potential movements of the character in each state. In FIG. 6E, the character has reached a location where a right turn will not result in a crash into the wall, so “turn right” is added as an option. Said more generally, the set of available words or phrases can be varied with the game state, e.g., by generating the available words and phrases using a generative model based on the game state.

In addition, note that the explanation above involved the helper controlling the character during the help session. In this case, the messages convey the actions being taken by the helper. In other cases, the helpee may maintain control, in which case the messages can correspond to instructions to the player receiving assistance, and it is up to that player to actually control their character according to the received messages.

As also noted, symbols can be employed in place of, or in addition to, natural language messages. As shown in FIG. 6G, a set of two symbols is provided. Here, the symbols are thumbs-up or thumbs-down gestures, e.g., selected to convey that the helper has found the gem or has not found the gem without allowing direct natural language communication. In other examples, directional arrows, stop signs, or other types of symbols can be employed to provide instructions to a video game player. The set of available symbols can also be varied based on game state, e.g., using a generative model. In some cases, the available symbols can include a set of standard symbols that are available irrespective of game state—e.g., thumbs-up and thumbs-down. Standard symbols can be provided with other symbols that change with game state, e.g., directional arrows only for allowable movements considering the location of a character and/or only for directions that will not cause negative consequences (e.g., moving into a lava pit, crashing, getting stuck, etc.).

In other implementations, a generative language model can be employed to generate text narrating a help session independently of the helper. For instance, the helper can control the character without any communication with the helpee. Instead, a generative language model can be employed to generate explanations of what the character is doing based on output of the video game. In other cases, the helper can use natural language communication (e.g., text or voice) but the communication is moderated by the generative language model, e.g., by removing or revising inappropriate terms. In still further cases, the helper can enter a short message, e.g., “right” and a generative language model can be employed for expanding the message in a context-sensitive manner, e.g., “turn right just after the wall.”

As also noted, computer vision can be employed to modify video output of a game to remove certain content. For instance, if a game allows a helper to draw using a pencil or paintbrush, it is possible the helper could draw something inappropriate. This can be mitigated using computer vision in several ways. For instance, some implementations can simply mask out any manual drawings by a helper, irrespective of what is being drawn. Other implementations can detect the object is being drawn and then determine whether the detected object is allowed or not. In FIG. 6H, this is illustrated by removing the cheers emoji. Here, a generative language model is employed to generate a natural language term (“congrats”) that conveys a similar meaning as the cheers emoji in an age-appropriate manner.

As also noted, helper selection can be employed as a technique for restricting help sessions. Some implementations can maintain a list of pre-approved human helpers, e.g., based on prior help sessions where those helpers did not use foul language or otherwise cause inappropriate content to be viewed or heard by children. In other implementations, human helpers can be used when the helpee is above a designated age threshold, and otherwise, a trained machine learning model can be employed as a helper. If the trained machine learning model has generative language capability, it may self-narrate the help session, e.g., describing the actions taken during the help session using text.

Furthermore, note that the help session restriction techniques provided above can also be employed for video game players that are not necessarily children. For instance, users may be able to opt-in to restricted help sessions that limit the help session as described herein. In other causes, all users may, by default, be provided restricted help sessions unless they choose to opt-in to unrestricted help sessions. In still further implementations, users can provide customized preferences for specific types of restrictions. For instance, one user might allow unrestricted chat but no voice communication, whereas another user (e.g., an adult using a headset in a room with a child) might prefer unrestricted voice communication while limiting chat communication to a set of symbols.

In some cases, users can select help session restriction options on a session-by-session basis, e.g., opting into voice or chat communication for some help sessions and not others. For instance, a parent might specify that a child cannot engage in text or voice communications during help sessions. However, the parent may be able to override these restrictions for a help session where the helper is a trusted relative or friend. For instance, a parent may configure a child account with a set of restrictions on help sessions. If the parent wishes to remove one or more restrictions for a help session involving a trusted relative or friend, the parent may do so by authenticating with the operating system and/or remote gaming service by password, PIN, facial recognition, two-factor authentication, etc. The operating system or remote gaming service can temporarily remove restrictions selected by the parent for the duration of the help session.

### Technical Effect

As noted above, the disclosed implementations can be employed to automatically designate and detect help session triggering conditions. As a result, human-computer interaction can be improved by having a computer initiate a help session for a user. For instance, users may not be able to accurately determine when a help session is appropriate to initiate or to terminate. Using the disclosed techniques, specific in-game circumstances can be accurately detected and help sessions can be offered in a manner that encompasses scenarios where help is appropriate, based on prior interactions by other users with a given video game.

In further implementations, specific techniques can be employed to preserve processing, memory, and/or network bandwidth. For instance, some implementations can snapshot video output of a given game at a specified interval, e.g., every 30 seconds. Thus, instead of analyzing every video frame, far fewer frames are analyzed, and computing resources can be conserved. As another example of computing resource preservation, a large server-based generative model can be employed to evaluate massive amounts of prior gameplay data and designate help session triggering or ending conditions. Then, those conditions can be distributed to client devices where smaller (e.g., vision-only) models can detect the conditions in video game output and trigger help sessions.

In addition, the disclosed techniques also provide for automated restriction of help sessions in a manner that further improves human-computer interaction. Consider an alternative where video game helpers have unlimited ability to control a video game for another player during a help session. This could result in a variety of negative consequences for children that are receiving assistance. By restricting inputs (and, in some cases, outputs) during a help session, the disclosed implementations can help ensure that age-appropriate content is provided to children while still enabling other users to control help sessions involving children.

### Device Implementations

As noted above with respect to FIG. 8, system 800 includes several devices, including a console client device 810, a mobile client device 820, and a game server 830. As also noted, not all device implementations can be illustrated, and other device implementations will be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of storage resources storing computer-readable instructions. When executed, the computer-readable instructions can cause the hardware processors to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable medium” can include signals. In contrast, the term “computer-readable storage medium” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 840. Without limitation, network(s) 840 can include one or more local area networks (LANs), wide area networks (WANs), the Internet, and the like.

Various examples are described above. Additional examples are described below. One example includes a computer-implemented method comprising determining age information relating to a video game player engaged in a gaming session involving a video game; initiating a help session involving a helper assisting the video game player with gameplay of the video game; performing age-based restriction of the help session based at least on the age information, and ending the help session and returning to the gaming session involving the video game player.

Another example can include any of the above and/or below examples where the age-based restriction involves selecting a trained machine learning model as the helper when the age information indicates the video game player is below a designated age threshold.

Another example can include any of the above and/or below examples where the age-based restriction involves selecting a human as the helper when the age information indicates the video game player is above the designated age threshold.

Another example can include any of the above and/or below examples where the age-based restriction involves selecting the helper from a pool of human helpers based on prior help sessions by the human helpers.

Another example can include any of the above and/or below examples where the helper is a human helper and the age-based restriction involves preventing natural language communication from the human helper to the video game player.

Another example can include any of the above and/or below examples where the helper is a human helper and the age-based restriction involves providing a set of available symbols for the human helper to select from to communicate to the video game player.

Another example can include any of the above and/or below examples where the method further comprises varying the set of available symbols based on game state.

Another example can include any of the above and/or below examples where the helper is a human helper and the age-based restriction involves providing a set of available words or phrases for the human helper to select from to communicate to the video game player.

Another example can include any of the above and/or below examples where the method further comprises varying the set of available words or phrases based on game state of the video game during the help session.

Another example can include any of the above and/or below examples where the method further comprises generating the set of available words or phrases with a generative language model based on the game state.

Another example can include any of the above and/or below examples where the helper is a human helper and the age-based restriction involves receiving a natural language message from the human helper during the help session, and moderating the natural language message using a generative language model.

Another example can include any of the above and/or below examples where the helper is a human helper and the age-based restriction involves receiving a natural language message from the human helper during the help session, and expanding the natural language message using a generative language model.

Another example can include any of the above and/or below examples where the age-based restriction involves narrating the help session using a generative language model.

Another example can include any of the above and/or below examples where the age-based restriction involves employing a computer vision model to detect designated visual content in output of the video game, and preventing the video game player from viewing the designated visual content.

Another example can include any of the above and/or below examples where the method further comprises determining the age information using a trained machine learning model.

Another example can include a system comprising processing resources, and storage resources storing computer-readable instructions which, when executed by the processing resources, cause the processing resources to determine age information relating to a video game player engaged in a gaming session involving a video game; initiate a help session involving a helper assisting the video game player with gameplay of the video game; perform age-based restriction of the help session based at least on the age information, and end the help session and return to the gaming session involving the video game player.

Another example can include any of the above and/or below examples where the computer-readable instructions, when executed by the processing resources, cause the processing resources to, based on the age information, remove one or more words from a natural language message received from the helper.

Another example can include any of the above and/or below examples where the computer-readable instructions, when executed by the processing resources, cause the processing resources to maintain a list of pre-approved helpers for video game players below a designated age threshold, and select the helper from the list of pre-approved helpers when the age information indicates the video game player is below the designated age threshold.

Another example can include any of the above and/or below examples where provided on a server in communication with a client device of the helper and another client device of the video game player.

Another example can include a computer-readable storage medium storing computer-readable instructions which, when executed by a hardware processing unit, cause the hardware processing unit to perform acts comprising determining age information relating to a video game player engaged in a gaming session involving a video game; initiating a help session involving a helper assisting the video game player with gameplay of the video game; performing age-based restriction of the help session based at least on the age information, and ending the help session and returning to the gaming session involving the video game player.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
determining age information relating to a video game player engaged in a gaming session involving a video game;
initiating a help session involving a helper assisting the video game player with gameplay of the video game;
performing age-based restriction of the help session based at least on the age information; and
ending the help session and returning to the gaming session involving the video game player.

2. The computer-implemented method of claim 1, wherein the age-based restriction involves:
selecting a trained machine learning model as the helper when the age information indicates the video game player is below a designated age threshold.

3. The computer-implemented method of claim 2, wherein the age-based restriction involves:
selecting a human as the helper when the age information indicates the video game player is above the designated age threshold.

4. The computer-implemented method of claim 1, wherein the age-based restriction involves:
selecting the helper from a pool of human helpers based on prior help sessions by the human helpers.

5. The computer-implemented method of claim 1, wherein the helper is a human helper and the age-based restriction involves preventing natural language communication from the human helper to the video game player.

6. The computer-implemented method of claim 1, wherein the helper is a human helper and the age-based restriction involves:
providing a set of available symbols for the human helper to select from to communicate to the video game player.

7. The computer-implemented method of claim 6, further comprising:
varying the set of available symbols based on game state.

8. The computer-implemented method of claim 1, wherein the helper is a human helper and the age-based restriction involves:
providing a set of available words or phrases for the human helper to select from to communicate to the video game player.

9. The computer-implemented method of claim 8, further comprising:
varying the set of available words or phrases based on game state of the video game during the help session.

10. The computer-implemented method of claim 9, further comprising:
generating the set of available words or phrases with a generative language model based on the game state.

11. The computer-implemented method of claim 1, wherein the helper is a human helper and the age-based restriction involves:
receiving a natural language message from the human helper during the help session; and
moderating the natural language message using a generative language model.

12. The computer-implemented method of claim 1, wherein the helper is a human helper and the age-based restriction involves:
receiving a natural language message from the human helper during the help session; and
expanding the natural language message using a generative language model.

13. The computer-implemented method of claim 1, wherein the age-based restriction involves narrating the help session using a generative language model.

14. The computer-implemented method of claim 1, wherein the age-based restriction involves:
employing a computer vision model to detect designated visual content in output of the video game; and
preventing the video game player from viewing the designated visual content.

15. The computer-implemented method of claim 1, further comprising:
determining the age information using a trained machine learning model.

16. A system comprising:
processing resources; and
storage resources storing computer-readable instructions which, when executed by the processing resources, cause the processing resources to:
determine age information relating to a video game player engaged in a gaming session involving a video game;
initiate a help session involving a helper assisting the video game player with gameplay of the video game;
perform age-based restriction of the help session based at least on the age information; and
end the help session and return to the gaming session involving the video game player.

17. The system of claim 16, wherein the computer-readable instructions, when executed by the processing resources, cause the processing resources to:
based on the age information, remove one or more words from a natural language message received from the helper.

18. The system of claim 16, wherein the computer-readable instructions, when executed by the processing resources, cause the processing resources to:
maintain a list of pre-approved helpers for video game players below a designated age threshold; and
select the helper from the list of pre-approved helpers when the age information indicates the video game player is below the designated age threshold.

19. The system of claim 16, provided on a server in communication with a client device of the helper and another client device of the video game player.

20. A computer-readable storage medium storing computer-readable instructions which, when executed by a hardware processing unit, cause the hardware processing unit to perform acts comprising:
determining age information relating to a video game player engaged in a gaming session involving a video game;
initiating a help session involving a helper assisting the video game player with gameplay of the video game;
performing age-based restriction of the help session based at least on the age information; and
ending the help session and returning to the gaming session involving the video game player.
